(19) United States
(12) Patent Application Publication
(10) Pub. No.: US 2003/0044618 A1
(43) Pub. Date: Mar. 6, 2003

(54) Bromine-containing flame retardant acrylic oligomers

(76) Inventors: Mingxin Fan, West Chester, PA (US); Gary Ceska, Exton, PA (US); James Horgan, West Chester, PA (US)

Correspondence Address: COZEN AND O'CONNOR, 1900 MARKET STREET, PHILADELPHIA, PA, 19103, US

(21) Appl. No.: 09/932,492

(22) Filed: Aug. 17, 2001

(51) Int. Cl. B32B 27/38

(52) U.S. Cl. 428/413

(57) ABSTRACT

A polymerizable epoxy (meth)acrylate oligomer obtained by reacting (a) one or more bromine-containing epoxy resins; and (b) one or more (meth)acrylate functional acids, process for preparing the oligomer, coatings and adhesives, and articles comprising the coating or adhesive, especially optical fiber, lens, and communication device.

### BACKGROUND OF THE INVENTION

This invention relates to the field of imparting flame retardancy to coatings, adhesives, and light carrying acrylic materials.

Ultraviolet light and electron beam (UV/EB) curing methods for coatings, adhesives, and light carrying acrylic materials are becoming more and more popular due to their low or zero volatile organic compound levels (VOC) and high productivity. Acrylic monomers and oligomers have been developed especially for UV/EB curable systems.

To impart fire and flame retardance to structural materials for airplanes and motor vehicle construction, electrical and electronic applications, coatings, and adhesives, bromine and phosphorus-containing additives have been used. However, in the special case of acrylic optical communication materials such as fiber, materials with high refractive indices are required, but previously available flame retardant additives reduce the refractive indices. Prior to the present invention, there has not been a commercially acceptable flame retardant system for acrylic materials for applications where high refractive indices are required.

The previously available additives which can be used to enhance the fire and flame retardance of UV and EB curable acrylic oligomers are non-reactive and can not be incorporated into a crosslinked network. Examples of such non-reactive flame retardant materials include brominated dialkyl phthalate, dioctyl tetrabromophthalate, brominated styrene polymers, and brominated Bisphenol A compounds. These non-reactive bromine-containing materials are typically high melting solids and are not compatible with monomers and oligomers in radiation cure systems, resulting in opaque final properties. For these reasons, clear, radiation curable, flame retardant acrylic compositions useful for optical applications are very difficult to obtain.

It is therefore an objective of this invention is to provide flame retardant acrylic compositions, methods of making them, and improved coating and adhesive compositions.

Another objective of this invention is to provide flame retardant materials with high refractive indices for optical applications such as optical lenses, optical devices, and optical/electrical hybrid devices, the improved lenses and optical and optical/electrical devices, and related methods of preparation and use.

### SUMMARY OF THE INVENTION

These objects, and other objects as will become apparant from the following disclosure, are achieved by the present invention which comrises in one aspect flame retardancy-imparting, polymerizable (meth)acrylate oligomers which are completely compatible with UV/EB curable monomers and oligomers and are especially useful in applications where high refractive indices are desired. The term “(meth)acrylate” is used herein as an abbreviation to mean both acrylates and methacrylates. These new materials contain bromine which enhances the fire/flame retardant properties and increases the refractive indices.

The oligomers of the invention are prepared by reacting (a) one or more (meth)acrylic acid or carboxyl group-containing (meth)acrylate monomers with (b) one or more bromine-containing epoxy resins.

The oligomers will contain (meth)acrylate functionalities and can be reacted or crosslinked with free radical mechanism such as peroxides or radiation curing processes.

In another aspect, the invention comprises coating and adhesive compositions prepared by radiation curing the aforementioned oligomer.

The invention also comprises the process of preparing such bromine-containing oligomers, a process of curing the bromine-containing oligomers, and articles having high refractive index which are coated with the radiation cured bromine-containing oligomers, or contain a radiation cured adhesive based on the bromine-containing oligomers.

### DETAILED DESCRIPTION OF THE INVENTION AND THE PREFERRED EMBODIMENTS

As mentioned above, the oligomers are prepared according to the invention by reacting (a) one or more (meth)acrylic acid or carboxyl group-containing (meth)acrylate monomers with (b) one or more bromine-containing epoxy resins.

Suitable (meth)acrylic acid or carboxyl group-containing (meth)acrylate monomers (a) include acrylic acid, methacrylic acid, hydroxyethyl (meth)acrylate/succinic anhydride reaction product, hydroxyethyl (meth)acrylate/phthalic anhydride adduct, and hydroxyethyl (meth)acrylate. Other hydroxy-containing (meth)acrylates and acid anhydrides can be used to generate the desired acid functional (meth)acrylates.

Suitable bromine-containing epoxy resins include Brominated bisphenol-A type epoxy resin, brominated solid epoxy resin of the epichlorohydrin-tetrabromo bisphenol-A type, solid flaked brominated epoxy resin, and brominate epoxy oligomer, having epoxy equivalent weights ranging from about 300 to 600 g/eq, and viscosities from about 140 cPs@25° C. to semi-solid or powder, commercially available from Dow Chemical Company under the D.E.R. 530, 538, 542, 560, and 592, and from Dead Sea Bromine Group, Ltd., as F2001 and F2200.

The bromine-containing (meth)acrylate oligomers of the invention are prepared by with any process wherein at least one species of (a) and (b) are introduced into a reactor and heated. The molar ratio of (a) to (b) can vary, but is preferably about 0.2 to about 2.0. A viscous oligomer product is obtained.free radically polymerizable and can be UV/EB cured free radically. The number average molecular weight is typically 500 to 10,000.

The epoxy (meth)acrylate oligomers of the invention are more compatible with typical UV/EB curable monomers and oligomers, possibly due to the less symmetric nature of their molecular structure. They can be used for reactive flame retardants either alone or in combination with phosphorus containing materials. They can also be used as high refractive index materials for optical lenses and optical coatings for optical communication devices. They can be used as coatings for other articles and as adhesives where flame retardancy is desired. They are free radically polymerizable and can be UV/EB cured free radically. They can also be used as high refractive index materials for optical lens, optical coatings for optical communication devices.

The following examples illustrate a few embodiments.

### EXAMPLES

### Example 1

### Preparation of Low Molecular Weight Bromine-Containing Epoxy Acrylate

2.5 g of 4-methoxyphenol, 5.1 g of triphenylphosphine, 655.0 g of bromine-containing epoxy resin (DER542, Dow Chemical Company) and 145.0 g of acrylic acid along with 200.0 g of SR238 (hexanediol diacrylate, Sartomer Company) were charged into a reactor, the mixture was stirred and heated to 100° C. The acrylation reaction completed in three hours. A viscous oligomer was obtained with viscosity of 475 cps at 65° C. and refractive index of 1.56 at 26° C.

### Example 2

### Preparation of High Molecular Weight Bromine-Containing Epoxy Acrylate

To a reactor 4.7 g of triphenylphosphine, 2.4 g of 4-methoxyphenol, 190 g of SR238 (hexanediol diacrylate, Sartomer Company)), and 105.3 g of acrylic acid, and 644.7 g of DER560 (Dow Chemical) were added. The reaction was carried out following the above procedure and a viscous oligomer was obtained with 65° C. viscosity of 1,600 cps and refractive index of 1.58 at 26° C.

### Example 3

### Compatibility Test with Radiation Curable Acrylate Monomers

The oligomers prepared in Examples 1 and 2 were tested for compatibility with commonly used acrylates. All the tests indicate that the oligomers of this invention are completely compatible.

| Compatibility test | A | B | C | D | E | F | G | H |
|---|---|---|---|---|---|---|---|---|
| E1 | 5 | 5 | 5 | 5 | | | | |
| E2 | | | | | 5 | 5 | 5 | 5 |
| TPGDA | 5 | | | | 5 | | | |
| HDDA | | 5 | | | | 5 | | |
| TMPTA | | | 5 | | | | 5 | |
| EOTMPTA | | | | 5 | | | | 5 |
| Final Mixture | C | C | C | C | C | C | C | C |

The numbers are the weight in grams. E1 is the oligomer from example 1, E2 is the oligomer from example 2, TPGDA is tripropyl glycol diacrylate, HDDA is hexanediol diacrylate, TMPTA is trimethylolpropane triacrylate, EOTMPTA is ethoxylated trimethylolpropane triacrylate. C means that the final mixture is clear and compatible.

### Example 4

### UV Cure of the Bromine-Containing Oligomers

The oligomers prepared in Example 1 and 2 were tested in UV radiation cure. Oligomers from Example 1 and 2 were blended with 5% photoinitiator (KIP 100F, available from Sartomer Company, Inc.) and applying to aluminium panel using a #10 application wire rod and then curing the coated substrates on a UV curing unit equipped with a 300 watts/inch Hg lamp at a speed of 50 feet per minute (fpm). The blends were completely cured and hard coatings were obtained, the Tg of the final cured coatings are 92C and 64C respectively.

While the invention has been described in sufficient detail for those skilled in this art to make and use it, various modifications, alternatives, and improvements should become readily apparant without departing from the spirit and scope of the invention.

What is claimed is:

1. A polymerizable epoxy (meth)acrylate oligomer obtained by reacting (a) one or more bromine-containing epoxy resins; and (b) one or more (meth)acrylate functional acids.

2. Oligomer of claim 1 wherein the bromine-containing epoxy resin is selected from the group consisting of brominated bisphenol A and brominated bisphenol F epoxy resins.

3. Oligomer of claim 1 wherein the bromine-containing epoxy resin is polymerized from tetrabromobisphenol A.

4. Oligomer of claim 1 wherein the bromine-containing epoxy resin has a molecular weight of about 500 to 10,000 (number average).

5. Oligomer of claim 1 wherein the molar ratio of (a) to (b) is about 0.2 to 2.0.

6. Oligomer of claim 1 wherein one or more bromine-containing epoxy resins (a) and one or more (meth)acrylate functional acids (b) are mixed together and reacted.

7. Oligomer of claim 1 wherein one or more bromine-containing epoxy resins (a) and one species of (meth)acrylate functional acid (b) are reacted so as to form a partially acrylated resin, followed by reaction of a different species of (meth)acrylate functional acid (b).

8. Process of preparing a flame retardancy imparting oligomer comprising reacting (a) one or more bromine-containing epoxy resins; and (b) one or more (meth)acrylate functional acids.

9. Coating and adhesive compositions prepared by polymerizing the oligomers of claim 1.

10. Coating and adhesive compositions prepared by radiation curing the oligomer of claim 1.

11. A composition comprising a compatible mixture of one or more oligomers of claim 1 with one or more (meth)acrylic monomers.

12. Composition of claim 11 wherein the one or more (meth)acrylic monomers are selected from the group consisting of tripropyl glycol diacrylate, hexanediol diacrylate, trimethylolpropane triacrylate, and ethoxylated trimethylolpropane triacrylate.

13. A radiation cured coating or adhesive prepared by curing a composition of claim 11 with UV or EB radiation.

14. Composition of claim 11, further including one or more flame retardant additives in addition to the oligomers.

15. Composition of claim 14 wherein the one or more flame retardant additives in addition to the oligomers are selected from phosphorus containing compounds.

16. An article in the form of an optical fiber, optical lens, and optical communication device which is coated with, or contains adhesive derived from, an oligomer of claim 1.

17. Article of claim 17 wherein the oligomer is UV or EB cured.
